(19) United States
(12) Patent Application Publication
(10) Pub. No.: US 2015/0084853 A1
(43) Pub. Date: Mar. 26, 2015

(54) Method and System for Mapping for Movement Trajectory of Emission Light Source Application Trajectory Thereof

(71) Applicant: Jeenon, LLC, Santa Clara, CA (US)

(72) Inventors: Dongge Li, Xi'an (CN); Wei Wang, Xi'an (CN)

(21) Appl. No.: 14/371,421

(22) PCT Filed: Jan. 9, 2013
(86) PCT No.: PCT/CN2013/070287

§ 371 Date: Dec. 1, 2014

(30) Foreign Application Priority Data
Jan. 9, 2012 (CN) 201210004810.5

(51) Int. Cl. G06F 3/03

(52) U.S. Cl. CPC G06F 3/0304
USPC 345/156

(57) ABSTRACT

An objective of the present invention is to provide a method and system for mapping a motion trace of a light-emitting source to an application trace thereof. Herein, an application detection device obtains imaging information of the light-emitting source; and detects an input mode of the light-emitting source to determine an application mapping curve corresponding to the input mode; and obtains a motion trace of the light-emitting source based on the imaging information; and obtains an application trace corresponding to the motion trace based on the motion trace by means of the application mapping curve; and. outputs the application trace to an external device. Compared with the prior art, the present invention implements adaptively matching application mapping curves and obtaining application traces for different input modes of the light-emitting source, which improves user experience.

### FIELD OF THE INVENTION

The present invention relates to the technical field of intelligent control, and in particular to a technique of mapping a motion trace of a light-emitting source to an application trace thereof.

### BACKGROUND OF THE INVENTION

In the intelligent control fields such as smart TV, motion sensing interaction, and virtual reality, etc., a detecting device detects certain signals sent from an input device, for example, electromagnetic signals, sound signals, or optical signals, to perform corresponding input mapping and then an application trace corresponding to a motion trace of the input device is displayed on a screen. However, such input mapping is always a simple way of mapping, for example, a mapping using an MEMS sensor based on acceleration, a simple two-dimensional mapping using a gravity sensor, etc., which has poor user experience.

Therefore, it becomes an imminent technical problem to be solved by those skilled in the art to provide a method for mapping a motion trace of a light-emitting source to an application trace thereof.

### SUMMARY OF THE INVENTION

An objective of the present invention is to provide a method and system for mapping a motion trace of a light-emitting source to an application trace thereof.

According to one aspect of the present invention, a method for mapping a motion trace of a light-emitting source to its application trace is provided. Herein, the method comprises the following steps:
obtaining imaging information of the light-emitting source;

wherein the method further comprises:

a. detecting an input mode of the light-emitting source to determine an application mapping curve corresponding to the input mode;

b. obtaining a motion trace of the light-emitting source based on the imaging information;

c. obtaining an application trace corresponding to the motion trace, by means of the application mapping curve, based on the motion trace;

d. outputting the application trace to an external device.

Preferably, the operation of detecting the input mode of the light-emitting source comprises:
determining the input mode of the light-emitting source based on the current application of the external device.

Preferably, the application mapping curve comprises a three-dimensional application mapping curve.

More preferably, an amplification factor of the three-dimensional application mapping curve is adjusted based on a distance to the light-emitting source.

More preferably, the three-dimensional application mapping curve comprises a three-dimensional application mapping curve based on a three-dimensional rotational position of the light-emitting source.

Further, the step b comprises:
obtaining a three-dimensional rotational motion trace of the light-emitting source based on the imaging information.

As one of the preferred embodiments of the present invention, the application mapping curve is adjusted by historical state information of the light-emitting source.

As one of the preferred embodiments of the present invention, before the step b, the method further comprises:
detecting a current input state of the light-emitting source, so as to proceed further operation when the waiting time corresponding to the current input state expires.

As one of the preferred embodiments of the present invention, the method further comprises:
correcting a start point of the application trace based on a peak of movement feature of the motion trace or the application trace within a predetermined search time range;

wherein, the step d comprises:
outputting the corrected application trace to the external device.

As one of the preferred embodiments of the present invention, before the step d, the method further comprises:
correcting a corresponding input operation based on information relevant to operation of the input device from a start time of obtaining an input operation of the input device, so as to obtain a corrected input operation, till predetermined condition(s) for stopping the input operation correction being met;

wherein, the predetermined condition(s) for stopping the input operation correction comprises at least one of the following items:
a time period of movement of the light-emitting source reaching a predetermined correction delay time threshold;
a feature value of movement of the motion trace of the light-emitting source reaching a corresponding feature value threshold of movement;
a feature value of movement of the application trace of the light-emitting source reaching a corresponding feature value threshold of movement.

As one of the preferred embodiments of the present invention, the step b further comprises:
determining predicted position information of the light-emitting source based on historical movement feature information of the motion trace so as to smooth the motion trace.

As one of the preferred embodiments of the present invention, the input mode of the light-emitting source comprises a handwriting input mode.

Preferably, the application mapping curve comprises a linear curve.

Preferably, the method further comprises:
looking up a predetermined character database based on the application trace so as to obtain a character corresponding to the application trace;
outputting the character to the external device.

Preferably, in the handwriting input mode, the method further comprises:
determining an input area corresponding to the handwriting input mode based on a start point of the application trace.

As one of the preferred embodiments of the present invention, the input mode of the light-emitting source comprises a mouse input mode.

Preferably, the method further comprises:
obtaining control information transmitted by the light-emitting source based on the imaging information of the light-emitting source, and obtaining a mouse operation corresponding to the control information by means of looking up a predetermined control information table;
outputting an execution instruction of the mouse operation to the external device so as to execute the mouse operation at an input focus corresponding to the light-emitting source, and displaying the executing result corresponding to the mouse operation at the external device.

According to another aspect of the present invention, a system of mapping a motion trace of a light-emitting source to its application trace is provided. Herein, the system comprises a light-emitting source, a camera for capturing imaging information of the light-emitting source, a processing module, and an output module;

wherein the processing module is configured to:
detect an input mode of the light-emitting source to determine an application mapping curve corresponding to the input mode;
obtain a motion trace of the light-emitting source based on the imaging information;
obtain an application trace corresponding to the motion trace, by means of the application mapping curve, based on the motion trace;

wherein the output module is configured to output the application trace to an external device.

Compared with the prior art, the present invention determines an application mapping curve corresponding to an input mode of a light-emitting source, and then obtains an application trace of the light-emitting source through the application mapping curve based on a motion trace of the light-emitting source, thereby implementing adaptively matching application mapping curves and obtaining application traces for different input modes of the light-emitting source, which improves user experience.

### BRIEF DESCRIPTION OF THE SEVERAL VIEWS OF THE DRAWINGS

Through reading the following detailed depiction on the non-limiting embodiments with reference to the accompanying drawings, the other features, objectives, and advantages of the present invention will become more apparent.

FIG. 1 shows a diagram of a system for mapping a motion trace of a light-emitting source to an application trace thereof according to one aspect of the present invention;

FIG. 2 shows a diagram of a two-dimensional mouse application mapping curve according to the present invention;

FIG. 3 shows a diagram of indicating a three-dimensional rotational position of a light-emitting source according to the present invention;

FIG. 4 shows a flow chart of a method for mapping a motion trace of a light-emitting source to an application trace thereof according to another aspect of the present invention;

FIG. 5 shows a flow chart of a method for mapping a motion trace of a light-emitting source to an application trace thereof according to one preferred embodiment of the present invention;

FIG. 6 shows a flow chart of a method for mapping a motion trace of a light-emitting source to an application trace thereof according to another preferred embodiment of the present invention;

FIG. 7 shows a flow chart of a method for mapping a motion trace of a light-emitting source to an application trace thereof according to a further preferred embodiment of the present invention;

FIG. 8 shows a flow chart of a method for mapping a motion trace of a light-emitting source to an application trace thereof according to a still further preferred embodiment of the present invention;

FIG. 9 shows a flow chart of a method for mapping a motion trace of a light-emitting source to an application trace thereof according to a yet further preferred embodiment of the present invention.

Same or like reference numerals in the accompanying drawings represent the same or like components.

### DETAILED DESCRIPTION OF THE INVENTION

Hereinafter, the present invention will be further described in detail with reference to the accompanying drawings.

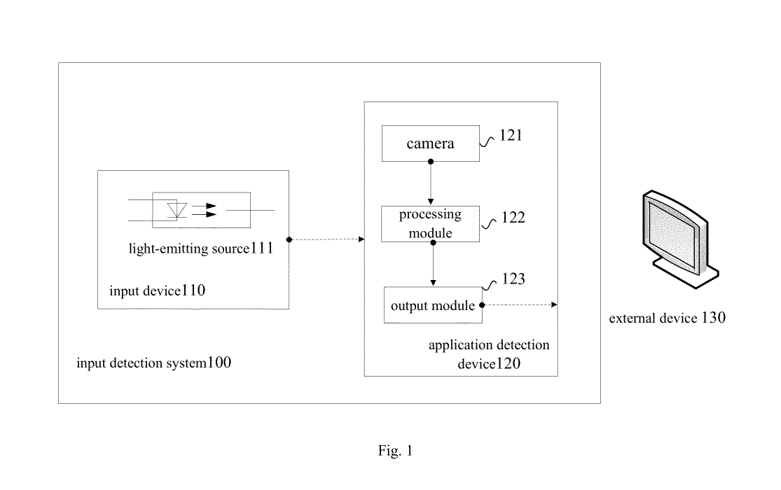

FIG. 1 is a system diagram according to one aspect of the present invention, showing a system for mapping a motion trace of a light-emitting source to an application trace thereof.

Here, an input detection system 100 comprises an input device 110 and an application detection device 120, wherein the input device 110 and the application detection device 120 are placed at two ends, respectively. The input device 110 comprises at least one light-emitting source 111. The application detection device 120 comprises at least one processing module 122 and at least one output module 123. Further, at least a camera 121 is built in or externally connected to the application detection device 120. The camera 121 shoots the light-emitting source 111 to obtain imaging information of the light-emitting source 111; the output module 123 is further connected to an external device 130.

Herein, the camera 121 shoots the light-emitting source 111 to obtain imaging information of the light-emitting source 111; the processing module 122 detects an input mode of the light-emitting source 111 to determine an application mapping curve corresponding to the input mode, obtains a motion trace of the light-emitting source 111 based on the imaging information of the light-emitting source 111, and obtains an application trace corresponding to the motion trace by means of the application mapping curve; and the output module 123 outputs the application trace to the external device 130.

In the present invention, the motion trace comprises one or more pieces of position information of the light-emitting source 111, and the application trace comprises one or more display positions corresponding to the light-emitting source 111 on a screen of the external device 130. Moreover, since the light-emitting source 111 is mounted to the input device 110, the position and motion trace of the input device 110 are represented by the position and motion trace of the light-emitting source 111, and they are used in equivalence.

For example, the camera 121 shoots the light-emitting source 111 to obtain a plurality of frames of images of the light-emitting source 111; the processing module 122 determines that the input mode of the light-emitting source 111 is a mouse input mode based on system default settings, and determines a mouse application mapping curve corresponding to the mouse input mode; the processing module 122 obtains, based on each frame of image of the light-emitting source 111, by means of a binocular stereo visual algorithm, a three-dimensional translational position (x, y, z) of the light-emitting source 111 corresponding to the each frame of image, i.e., the three-dimensional translational motion trace of the light-emitting source 111, wherein x denotes a horizontal coordinate of the light-emitting source 111 relative to a space origin, y denotes a vertical coordinate of the light-emitting source 111 relative to the space origin, and z denotes a depth coordinate of the light-emitting source 111 relative to the space origin; the processing module 122, based on each three-dimensional translational position (x, y, z) in the three-dimensional motion trace, through a mouse application mapping curve, for example X=f(x,y,z), Y=g(x,y,z), Z=h(x,y,z), calculates a corresponding mouse translational position (X, Y, Z), and then obtains a three-dimensional translational application trace of the light-emitting source 111; and the output module 123 outputs the three-dimensional translational application trace, i.e., each mouse translational position (X, Y, Z), to the external device 130, so as to present the three-dimensional translational application trace at the external device 130.

Those skilled in the art should understand that the above binocular stereo visual algorithm is only an example for obtaining the three-dimensional translational positions of the light-emitting source, and such example is only for illustrating the present invention conveniently and should not be regarded as any limitation to the present invention; other existing manners of computing a three-dimensional translational position of a light-emitting source or those manners possibly evolved in the future, if applicable to the present invention, should also be included within the protection scope of the present invention, which are incorporated here by reference.

The manners for the processing module 122 to detect an input mode of the light-emitting source 111 may be diverse. For example, determining the input mode of the light-emitting source 111 based on a control signal of the input device 110; e.g., determining a corresponding input mode by querying a predetermined control information table based on the control information; or, determining the input mode of the light-emitting source 111 based on the current application of the external device 130, e.g., if the current application is an input box, the corresponding input mode is a handwriting input mode; if the current application is a program menu, the corresponding input mode is a mouse input mode. The processing module 122 may detect a corresponding input mode of the light-emitting source 111 at the initial time of moving, or switch the input mode of the light-emitting source 111 when the current application of the external device 130 is changed.

Here, the application detection device 120 may comprise a mapping curve base for storing application mapping curves corresponding to various kinds of input modes, such as a mouse application mapping curve, a handwriting application mapping curve, etc.

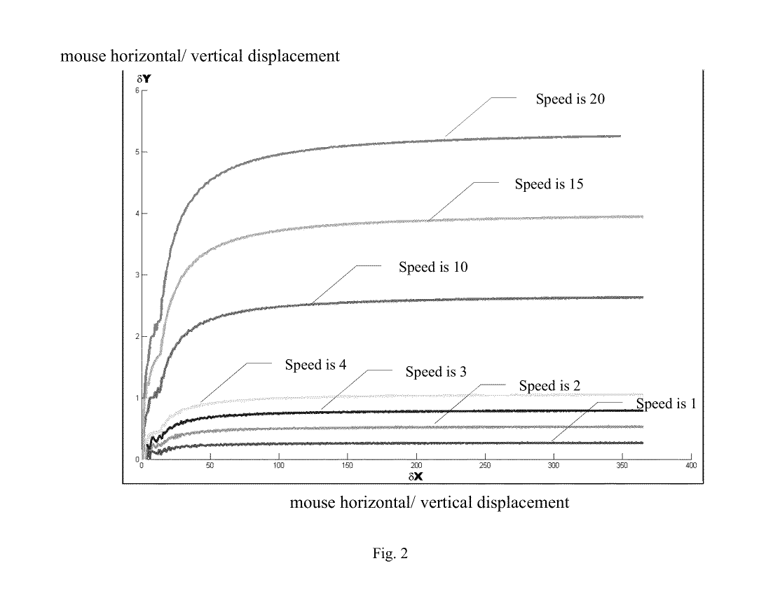

For example, FIG. 2 shows a plurality of two-dimensional mouse application mapping curves. In the present invention, the two-dimensional mouse application mapping curve may be a linear curve (i.e., linear transformation curve), quadratic curve, or multi-segment curve. Generally, in the x, y directions, same or different mapping curves are adopted to determine the moving position or speed of the mouse, respectively. In one example, for an imaging light spot of the light-emitting source 111 in the image, the moving distance of the imaging light spot between two adjacent frames of the image in x, y directions is mapped as a moving distance on the screen of the external device 130; moreover, the less the moving distance of the imaging light spot is, the more gentle is the mapping curve, i.e., the smaller is the slope, so as to prevent jitter; while the greater the moving distance of the imaging light spot is, the greater is the mapping curve slope. In another example, the two-dimensional mouse application mapping curve may also be used to map an absolute position of the imaging light spot to a display position on the screen.

In the present invention, the mouse application mapping curve may further comprise a three-dimensional mouse application mapping curve, and in its x, y, z directions, same or different mapping curves may be used to determine the moving position or speed of the mouse, respectively. A general expression for the three-dimensional mouse application mapping curve may be expressed as: X=f(x,y,z), Y=g(x,y,z), Z=h(x,y,z), wherein X, Y, Z denote the three-dimensional mouse position in a three-dimensional display interface or operation interface, x, y, z denote the detected three-dimensional translational position of the light-emitting source; f, g, h denote the mapping curves in respective directions, which may be a linear curve (i.e., linear transformation curve), quadratic curve, or multiple-segment curve. X, Y, Z may also denote position changes of the mouse, for example, the moving distance or speed of the mouse; likewise, x, y, z may also denote the position changes of the light-emitting source 111, for example, the moving distance or speed of the imaging light spot. Preferably, an application mapping curve for a corresponding input mode may be further set based on a specific application. For example, for a common application like webpage browsing, the display position of the mouse may be mapped based on the position of the light-emitting source 111, while for an application has a higher requirement on accuracy and sensitivity such as a game, the position change of the mouse may be mapped based on the position change of the light-emitting source 111.

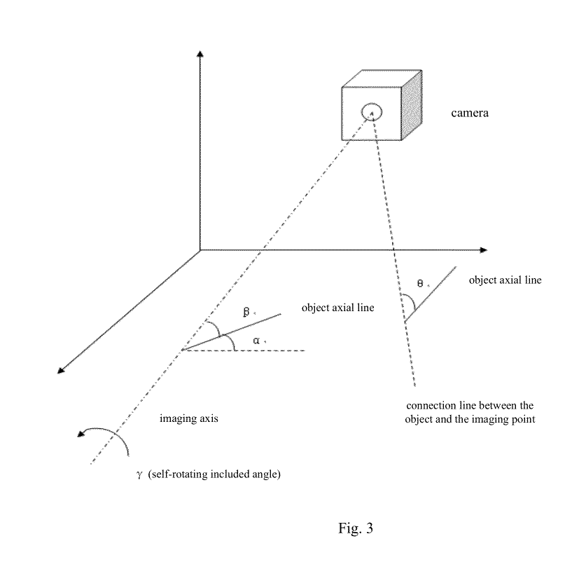

Further, for a three-dimensional application scenario which has a higher requirement on accuracy and sensitivity, the present invention may further provide a mouse application mapping curve based on the three-dimensional translational position and the three-dimensional rotational position of the light-emitting source 111, whose general expression may be expressed as X=f(x,y,z,α,β,γ), Y=g(x,y,z,α,β,γ), Z=h(x,y,z,α,β,γ). Here, with reference to FIG. 3, the three-dimensional rotational position of the light-emitting source 111 is denoted as (α,β,γ), wherein α denotes a horizontal direction angle of the light-emitting source 111 through its centroidal axis, β denotes a vertical direction angle of the light-emitting source 111 through its centroidal axis, and γ denotes a rotational angle of the light-emitting source 111 around its centroidal axis, i.e., the self-rotational angle of the light-emitting source 111. Further, the three-dimensional rotational position of the light-emitting source 111 may also be denoted as θ or (θ, γ), wherein θ denotes an included angle between the axial line of the light-emitting source 111 and the connection line from the light-emitting source 111 to the camera 122. After the included angle θ is obtained, the horizontal direction angle α and the vertical direction angle β of the light-emitting source 111 may be determined with reference to the three-dimensional translational position of the light-emitting source 111.

Here, the processing module 122 obtains the three-dimensional rotational position of the light-emitting source 111 in each frame of image based on the imaging information of the light-emitting source 111, and then further obtains the three-dimensional rotational motion trace of the three-dimensional rotational positions. For example, a corresponding included angle θ is calculated and obtained based on the circle radius r and the brightness I of the imaging light spot of the light-emitting source 111 by means of a predetermined included angle fitting curve θ=h(r, I); or, a corresponding included angle θ is obtained based on the circle radius r and brightness I of the imaging light spot of the light-emitting source 111 by means of looking up a predetermined light spot attribute-included angle sample table, and if the circle radius r and brightness I have not been added into the sample table, then the corresponding included angle θ may be obtained by various kinds of sample interpolation algorithms. The sample interpolation algorithms include, but not limited, to any existing interpolation algorithms or those interpolation algorithms possibly evolved in the future, which are applicable for the present invention, such as nearest neighbor interpolation, linear weight interpolation, and bicubic interpolation, etc.

Herein, enough samples, i.e., values of r and I (or other available light spot attributes) may be measured under different included angles θ between a certain step length, so as to establish the previously mentioned light spot attribute-included angle sample table; or to obtain the previously mentioned included angle fitting curve by fitting the mapping relationships between r, I and θ according to the minimal error criterion using a linear curve, quadratic curve, or polynomial curve. When sampling, within a valid working range, an LED light source with an optical feature that the included angle θ may uniquely be determined by the combination of r and I, should be selected.

Those skilled in the art should understand that the above included angle fitting curve and sample interpolation algorithms are only examples for obtaining a three-dimensional rotational position of the light-emitting source, and such examples are only for illustrating the present invention conveniently and should not be regarded as any limitation to the present invention; other existing manners of computing a three-dimensional rotational position of the light-emitting source or those manners possibly evolved in the future, if applicable to the present invention, should also be included within the protection scope of the present invention, which are incorporated here by reference.

In one example, Z=1, i.e., relative to a two-dimensional operation interface, the mouse only moves in X, Y directions; X=fₚ(x,y,z)*w1+f_{z}(α,β,γ)*w2, Y=gₚ(x,y,z)*w1+g_{z}(α,β,γ)*w2, wherein fₚ, gₚ are mapping functions for the three-dimensional translational position; f_{z}, g_{z} are mapping functions for the three-dimensional rotational position, and w1, w2 are individual influencing weights for the three-dimensional translational position and the three-dimensional rotational position. Likewise, x,y,z,α,β,γ may also denote variations in respective directions, for example, translational or rotational speeds, not actual position values; it is more helpful to applications such as 3D TV or 3D game, for example, performing menu rotation based on the rotational speed of the light-emitting source 111, or more accurately mapping motion of a personage in a 3D game based on the translational and rotational speeds of the light-emitting source 111.

Preferably, the application mapping curve may also be adjusted based on historical state information of the light-emitting source 111. Here, illustration is made with adjusting a three-dimensional application mapping curve as an example. The three-dimensional application mapping curve as adjusted based on relevant historical state information may be further expressed as X′=Dx*X=Dx*f, Y′=Dy*Y=Dy*g, Z′=Dz*Z=Dz*h, wherein Dx, Dy, and Dz denote the amplification factors of the mapping curve adjusted by the historical state information of the light-emitting source 111, e.g., its latest use state, It should be noted that those skilled in the art should understand the latest use stage may not only be used for adjusting the amplification factor, but may also be used to select different mapping curves f, g, h in some applications, thereby achieving an optimal positioning experience.

For example, the amplification factor of a mouse application mapping curve is adjusted by detecting the size of an imaging light spot or a distance of the light-emitting source 111 to the camera 121. When the distance of the light-emitting source 111 is near, the amplification factor of the mapping curve is small; when the distance of the light-emitting source 111 is far, the amplification factor of the mapping curve is large, such that the user's experience in using the input device in different distances is consistent. Preferably, the distance of the light-emitting source 111 may be estimated through face recognizing so as to adjust the amplification factor of the mapping curve. For example, the distance of the light-emitting source 111 is estimated based on the human face feature information with a distance nearest to the motion trace of the imaging light spot in the imaging information, such as the size of the human face, the distance between two eyes, the pixel width, etc.

In one example, the calculation equation for the amplification factor is specified below:

$$curF = ( 1.0 - i ) * preF + i * ( \frac{( z - Db ) * 0.5 + Db}{Db} )$$

curF: the amplification factor used in the current frame;

preF: the amplification factor used in the last frame, which is 1 for the first frame;

i: a parameter set by the user; the larger the i is, the faster the amplification factor changes; the smaller it is, the greater the amplification factor is affected by the accumulation of the preceding frame;

z: the distance from the input device 110 to the application detection device 120, i.e., the deep coordinate of the light-emitting source 111 with respect to the spatial origin;

Db: an average value of a plurality of distance Z, for example, it may be preset as 3.0 m.

After the curF is obtained by the above equation, it is multiplied to f in the X direction and g in the Y direction, respectively, so as to obtain the three-dimensional application mapping curve based on the latest use state.

In another example, the amplification factor for the mouse application mapping curve may also be adjusted based on the movement speed of the input device 110 during a recent time period. If the latest movement speed of the input device 110 is small, then the amplification factor of the mouse application curve becomes small therewith; while if the latest movement speed of the input device 110 is large, then the amplification factor of the mouse application mapping curve will become larger therewith. Therefore, when the user continuously performs delicate operations within a small scope, a small amplification factor helps to position accurately; when the user moves fast within a large scope, a large amplification factor helps to move fast.

Besides, for a handwriting application mapping curve, it may be a linear curve, including a two-dimensional application mapping curve and a three-dimensional application mapping curve. Similar to a mouse application mapping curve, the input of the handwriting application mapping curve may also be mapped to a screen position or position change of the handwriting input based on the position or position change (for example, moving distance or speed) of the light-emitting source 111. The transformation coefficient of the handwriting application mapping curve, i.e., the slope of the linear curve, may be set based on different applications. For example, for a common handwriting input application, if a character is inputted into the input box, its corresponding transformation coefficient is 5, i.e., 5 times of the moving distance of the light-emitting source 111 is mapped to the moving distance of the input focus on the screen; for a handwriting input application like palette, its corresponding transform coefficient may be 1, i.e., the position and motion trace of the light-emitting source 111 are directly mapped to the position and application trace of the input focus on the screen.

Preferably, in the present invention, for a simple application mapping curve, the corresponding display position may be directly calculated based on the position information of the light-emitting source 111. However, for a complex application mapping curve, a table may be pre-generated, so as to obtain the corresponding display position based on the position information of the light-emitting source 111 by means of looking up the table.

The light-emitting source 111 includes, but not limited to, any light emitting object applicable to the present invention including various kinds of spot light source, surface light source, etc., such as LED light source, infrared light source, OLED light source, etc. For the sake of simplifying the description, in most cases, the present invention illustrated the light-emitting source 111 with the LED light source as an example. However, those skilled in the art should understand that such example is only for simply explaining the present invention, which should not be construed as any limitation to the present invention.

The camera 121 includes, but not limited to, any image acquisition device applicable to the present invention and capable of sensing and acquiring images of such as LED visible light, infrared light, etc. For example, the camera 121 has 1) high enough acquisition frame rate, e.g. 15 fps or above; 2) suitable resolution, e.g. 640*480 or above; 3) short enough exposure time, e.g. 1/500 or shorter.

The processing modules 122 includes, but not limited to, any electronic device applicable to the present invention and capable of automatically performing numerical value calculation and/or various kinds of information processing according to pre-stored code, and the hardware of which includes, but not limited to, a microprocessor, EPGA, DSP, embedded device, etc. Further, in the present invention, the detection device 120 may include one or more processing modules 122; when the processing module 122 is plural, each processing module 122 may be assigned a particular information processing operation so as to implement parallel calculation, thereby improving the detection efficiency.

Besides, the external device 130 includes, but not limited to a TV, a set top box, or a mobile device, etc. The output module 123 and the external device 130 transmit data and/or information in various kinds of wired or wireless communications manners. For example, the output module 123 communicates with the external device 30 in a wired manner via a hardware interface such as a VGA interface, a USB interface, etc., or the output module 123 communicates with the external device 30 in a wireless manner such as Bluetooth, WIFI, etc. Those skilled in the art should understand that the above external device and the manners of communicating between the external device and the output module are only exemplary, and other existing external device and manners of communicating between the external device and the output module or other external device and manners of communicating between the external device and the output module possibly evolved in the future, if applicable to the present invention, should also be included within the protection scope of the present invention, which are incorporated here by reference.

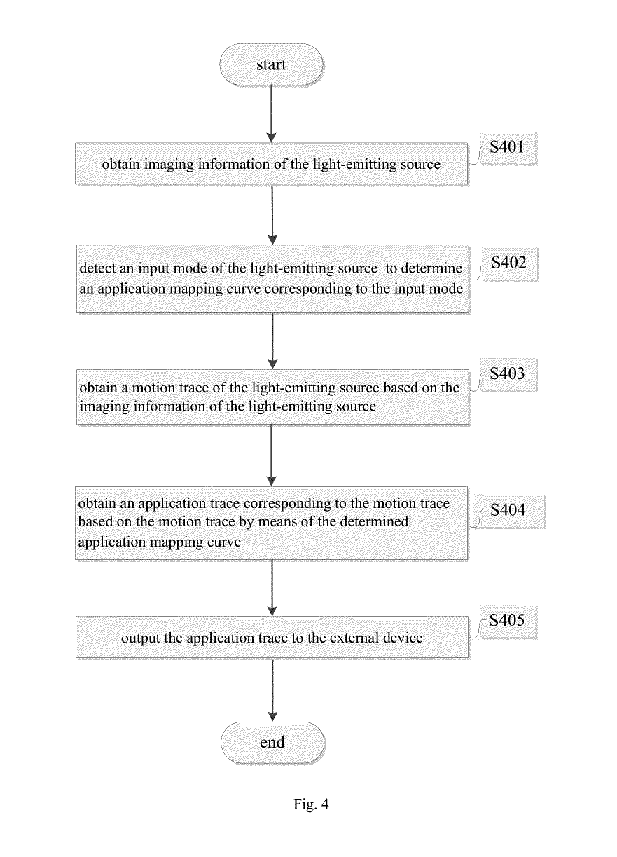

FIG. 4 is a flow chart of a method according to another aspect of the present invention, showing a process for mapping a motion trace of a light-emitting source to an application trace thereof.

Here, an application input system 100 comprises an input device 110 and an application detection device 120, wherein the input device 110 and the application detection device 120 are disposed at two ends, respectively. The input device 110 comprises at least one light-emitting source 111. The application detection device 120 has at least one built-in camera 121 or is externally connected to at least one camera 121. The camera 121 shoots a light-emitting source 111 to obtain imaging information of the light-emitting source 111; the application detection device 120 is further connected to an external device 130.

With reference to FIG. 1 and FIG. 4 in combination, in step S401, the camera 121 shoots to obtain imaging information of the light-emitting source 111; in step S402, the application detection device 120 detects an input mode of the light-emitting source 111 to determine an application mapping curve corresponding to the input mode; in step S403, the application detection device 120 obtains a motion trace of the light-emitting source 111 based on the imaging information of the light-emitting source 111; in step S404, the application detection device 120 obtains an application trace corresponding to the motion trace based on the motion trace by means of the determined application mapping curve; in step S405, the application detection device 120 outputs the application trace to the external device 130.

For example, the light-emitting source 111 is an LED light source mounted to an input control device 110, e.g., a remote controller; the user performs various kinds of actions in the space in a direction facing the camera 121 by operating the remote controller. The camera 121 is built in the application detection device 120. In step S401, the camera 121 adopts a frame rate three times of the flickering rate of the LED light source to shoot an image of the LED light source, so as to obtain the imaging information of the LED light source; in step S402, the application detection device 120 determines the current input mode of the LED light source, e.g., a mouse input mode, based on the flickering frequency of the LED light source by means of looking up a predetermined input mode mapping table, and obtains an application mapping curve corresponding to the mouse input mode; in step S403, the application detection device 120 obtains the motion trace of the LED light source, e.g., a plurality of pieces of position information of the LED light source, based on the imaging information of the LED light source; in step S404, the application detection device 120 obtains an application trace corresponding to the motion trace, e.g., the mouse motion trace presented on the external device 130, based on the motion trace of the LED light source by means of the above mentioned application mapping curve; in step S405, the application device 120 outputs the mouse motion trace to the external device 130 via a VGA interface connected to the external device 130, so as to present the mouse motion trace corresponding to the LED light source on a screen of the external device 130.

Preferably, the application detection device 120 further detects the current input state of the light-emitting source 111; and when the wait time corresponding to the input state expires, further detects the imaging information of the light-emitting source 111 to obtain its motion trace, to thereby obtain an application trace corresponding to the motion trace.

Or, the application detection device 120 detects the current input state of the light-emitting source 111; when the wait time corresponding to the input state expires, further obtains a corresponding application trace based on the motion trace of the light-emitting source 111 by means of the application mapping curve corresponding to the application mode.

Here, the application detection device 120 may detect the current input state of the light-emitting source 111, e.g., the input state or waiting state, based on the screen input position of the light-emitting source 111 or the moving mode of the light-emitting source 111. For example, the application detection device 120 may use the moving mode of the light-emitting source 111 to detect the input state and wait state: when the speed or distance of movement of the light-emitting source 111 or input cursor is larger than a threshold, it is an input state; otherwise, it is a wait state.

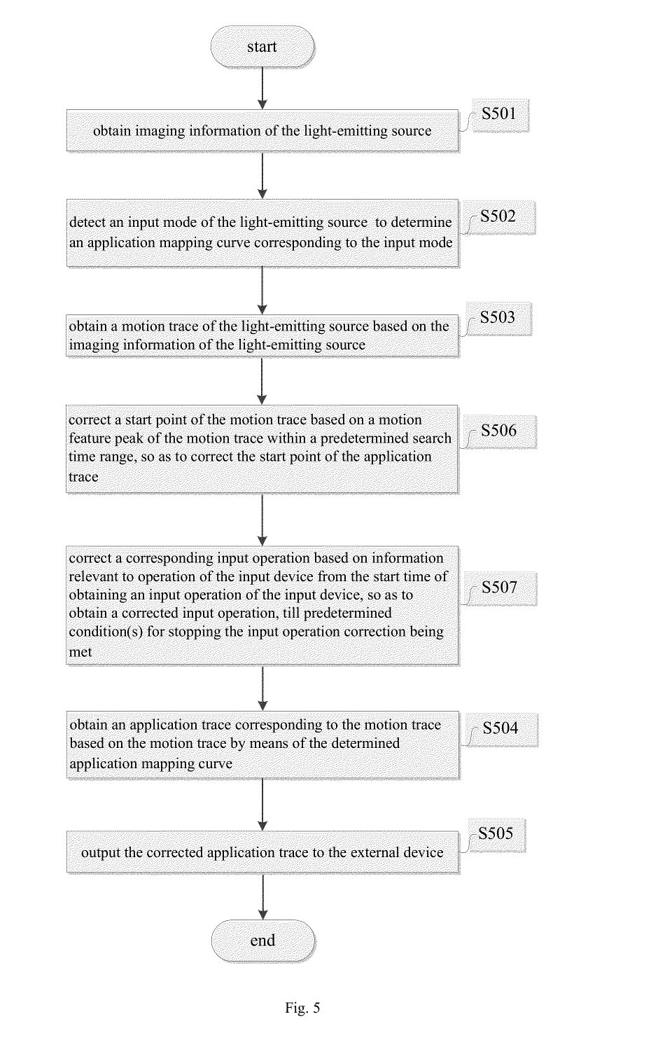

FIG. 5 is a flow chart of a method according to one preferred embodiment of the present invention, showing a process for mapping a motion trace of a light-emitting source to an application trace thereof.

Here, an application input system 100 comprises an input device 110 and an application detection device 120, wherein the input device 110 and the application detection device 120 are disposed at two ends, respectively. The input device 110 comprises at least one light-emitting source 111. The application detection device 120 has at least one built-in camera 121 or is externally connected to at least one camera 121. The camera 121 shoots a light-emitting source 111 to obtain imaging information of the light-emitting source 111; the application detection device 120 is further connected to an external device 130.

With reference to FIG. 1 and FIG. 5 in combination, in step S501, the camera 121 shoots to obtain imaging information of the light-emitting source 111; in step S502, the application detection device 120 detects an input mode of the light-emitting source 111 to determine an application mapping curve corresponding to the input mode; in step S503, the application detection device 120 obtains a motion trace of the light-emitting source 111 based on the imaging information of the light-emitting source 111; in step S506, the application detection device 120 corrects a start point of the motion trace based on a peak of movement feature of the motion trace within a predetermined search time range, so as to correct the start point of the application trace; in step S507, the application detection device 120 corrects a corresponding input operation based on information relevant to operation of the input device from the start time of obtaining an input operation of the input device, so as to obtain a corrected input operation, till predetermined condition(s) for stopping the input operation correction being met, wherein the predetermined condition(s) for stopping the input operation correction comprises a time period of movement of the light-emitting source reaching a predetermined correction delay time threshold and/or a feature value of movement of the motion trace of the light-emitting source reaching a corresponding feature value threshold of movement; in step S504, the application detection device 120 obtains an application trace corresponding to the corrected motion trace based on the corrected motion trace by means of the determined application mapping curve; in step S505, the application detection device 120 outputs the application trace to the external device 130.

In the present invention, the application detection device 120 corrects the start point of the motion trace based on a peak of movement feature of the motion trace of the imaging light spot within a predetermined search time range, so as to realize correction of for example a mouse position, a handwriting position. Taking the correction of a mouse position for an example, the detected positions of an imaging light spot in each frame of image within a recent period of time, e.g., 500 ms, are recorded; when receiving control information from a user, e.g., instructing a mouse click operation, the application detection device 120 calculates the recorded movement features of the imaging light spot in each frame of image within a maximum search time range before the click time, e.g., 100 ms or 200 ms; and calculates the mouse click start time based on these movement features, and takes the mouse position corresponding to the position of the imaging light spot at this time as the actual mouse click position, for example, taking the frame when the peak of the used movement feature values occurs within the search time range or its preceding frame as the click start time, and taking the corresponding mouse position as the actual mouse click position. Here, the movement features include, but not limited to, speed, acceleration or speed, and acceleration in the vertical direction of the imaging light spot in each frame of image, and variation amounts of the speed and acceleration in a neighboring frame, etc.

Besides, the application detection device 120 performs the corresponding input operation correction based on the operation-related information of the input device 110 from the start time of obtaining the input operation of the input device 110, so as to obtain a corrected input operation, for example, interpreting a mouse drag operation as a mouse click operation, or interpreting mouse drag+click operation as a mouse double-click operation, etc., till satisfying predetermined condition(s) for stopping the input operation correction, for example, the time period of movement of the light-emitting source 111 reaches a predetermined correction delay time threshold and/or the feature value of movement of the motion trace of the light-emitting source 111 reaches its corresponding feature value threshold of movement.

Here, the operation-related information includes, but not limited to, any subsequent related operation or motion performed by the input device in the current input operation state, which is applicable for the present invention, for example, the input device 110 moves in the mouse click state, thereby converting the mouse click operation into a mouse drag operation; or, the input device 110 clicks again in the mouse drag state, thereby converting the mouse drag operation into a mouse click operation, etc.

The correction to the input operation includes, but not limited to any operation applicable for the present invention for mapping one or more input operations of the user to other input operations based on a predetermined input operation mapping relationship, for example, interpreting a mouse drag operation into a mouse click operation, or interpreting a mouse drag+click operation into a mouse double click operation etc., so as to prevent jitter of the mouse or input focus on the screen, which may affect the user's use experience.

For example, at the start time when the application detection device 120 obtains an input operation of the input device 110, for example, after the mouse click position is determined in step S506, slight jitter occurs when the user operates the input device 110 in the mouse click state such that the mouse click operation is converted into a mouse drag operation; the application detection device 120 maps the mouse drag operation back to the mouse click operation based on a predetermined input operation mapping relationship and meanwhile detects whether to satisfy predetermined condition(s) for stopping an input operation correction; when the time period of movement of the light-emitting source 111 reaches a predetermined correction delay time threshold and/or the feature value of movement of the motion trace of the light-emitting source 111 reaches its corresponding feature value threshold of movement, the application detection device 120 stops input operation correction and restores the previous calculation of the motion trace of the light-emitting source 111.

For the predetermined condition of stopping the input operation correction, the application detection device 120 calculates the movement features of an imaging light spot in each frame of image after the start time of the input operation of the input device 110; when one or more movement features exceed their respective predetermined thresholds, the input operation correction is stopped, for example, stopping the input operation correction when the motion displacement of the imaging light spot is large enough. Or, a maximum anti jitter delay time is preset, e.g., 100 to 200 ms, such that from the start of the motion of the light-emitting source 111, when it reaches the maximum anti jitter delay time, stopping the input operation correction. Here, the movement features include, but not limited to, speed, acceleration or speed, acceleration in the vertical direction of the imaging light spot in each frame of image, and variation amounts of the speed and acceleration in a neighboring frame, or displacement over the initial position of the imaging light spot at the click time, or horizontal or vertical component of the displacement.

It should be noted that, those skilled in the art should understand that the correction operation of the motion trace start point and the input operation correction are not compulsorily implemented in one embodiment of the present invention, and the correction operation of the motion trace start point and the input operation correction may be applied to different embodiments of the present invention, respectively, so as to realize correction of the motion trace start point or the correction of the input operation in various preferred embodiments.

For example, the application detection device 120 determines that the input mode of the light-emitting source 111 is a mouse input mode based on the current application of the external device 130, e.g., webpage browsing; the application detection device 120 obtains imaging information of the light-emitting source 111 from the camera 121 and calculates the motion trace of the light-emitting source 111 based on the imaging information; the application detection device 120, before the start time of the motion trace, within a maximum search time range backward, e.g., 100 ms, calculates the speed of the imaging light spot in each frame within the previous 100 ms, and takes the position of the frame corresponding to the speed peak or of the preceding frame as the start position of the motion trace to correct the motion trace, for subsequently correspondingly correcting the application trace; then, the application detection device 120 obtains a corresponding application trace based on the re-determined motion trace by means of a mouse application mapping curve, and outputs the application trace to the external device 130.

Here, in the mouse input mode, the current position of the light-emitting source 111 will be interpreted by the application detection device 120 as the current mouse position. If slight jitter occurs during the process when the user operates the input device 110, the corresponding mouse position will also has slight jitter, which might cause the application detection device 120 to perform a mouse click operation at a wrong position or to interpret the mouse click operation as a mouse drag operation. In step S506 and step S507, click position correction and click jitter correction may be performed with respect to the above two issues, respectively.

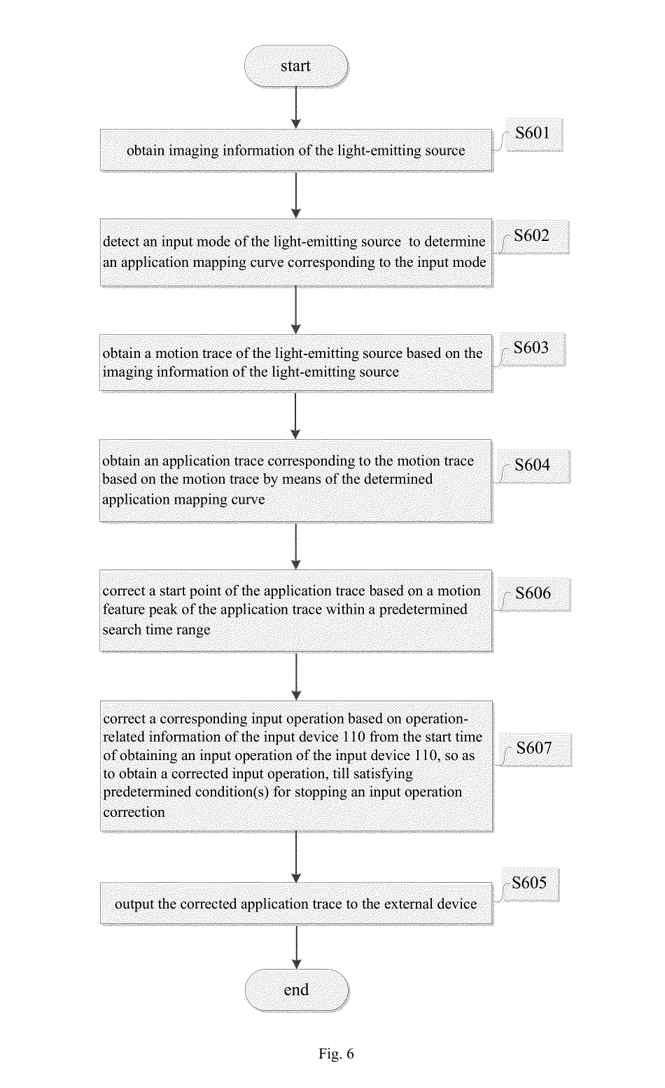

FIG. 6 is a flow chart of a method according to another preferred embodiment of the present invention, showing a process for mapping a motion trace of a light-emitting source to an application trace thereof.

Here, an application input system 100 comprises an input device 110 and an application detection device 120, wherein the input device 110 and the application detection device 120 are disposed at two ends, respectively. The input device 110 comprises at least one light-emitting source 111. The application detection device 120 has at least one built-in camera 121 or is externally connected to at least one camera 121. The camera 121 shoots a light-emitting source 111 to obtain imaging information of the light-emitting source 111; the application detection device 120 is further connected to an external device 130.

With reference to FIG. 1 and FIG. 6 in combination, in step S601, the camera 121 shoots to obtain imaging information of the light-emitting source 111; in step S602, the application detection device 120 detects an input mode of the light-emitting source 111 to determine an application mapping curve corresponding to the input mode; in step S603, the application detection device 120 obtains a motion trace of the light-emitting source 111 based on the imaging information of the light-emitting source 111; in step S604, the application detection device 120 obtains an application trace corresponding to the motion trace based on the motion trace by means of the determined application mapping curve; in step S606, the application device 120 corrects a start point of the application trace based on a peak of movement feature of the application trace within a predetermined search time range; in step S607, the application detection device 120 performs a corresponding input operation correction based on operation-related information of the input device 110 from the start time of obtaining an input operation of the input device 110, so as to obtain a corrected input operation, till satisfying predetermined condition(s) for stopping an input operation correction, wherein the predetermined condition(s) for stopping an input operation correction comprises a time period of movement of the light-emitting source 111 reaches a predetermined correction delay time threshold and/or a feature value of movement of the application trace of the light-emitting source 111 reaches its corresponding feature value threshold of movement; in step S605, the application detection device 120 outputs the corrected application trace to the external device 130.

In the present invention, the application detection device 120 corrects the start point of the application trace based on a peak of movement feature of the application trace of the imaging light spot within a predetermined search time range, so as to realize correction of for example a mouse position, a handwriting position. Taking the correction of a mouse position for an example, the detected mouse positions within a recent period of time, e.g., 500 ms, are recorded; when receiving control information from a user, for example, instructing a mouse click operation, the application detection device 120 calculates the recorded mouse movement features corresponding to each frame of image within a maximum search time range before the click time, e.g., 100 ms or 200 ms; and calculates the mouse click start time based on the mouse movement feature, and takes the mouse position at this time as the actual position of mouse click, for example, taking the frame when the peak of the used mouse movement feature value occurs within the search time range or its preceding frame as the click start time, and taking the corresponding mouse position as the actual mouse click position. Here, the mouse movement features includes, but not limited to, speed, acceleration or speed, and acceleration in the vertical direction of mouse movement in each frame of image, and variation amounts of the speed and acceleration in a neighboring frame, etc.

Besides, the application detection device 120 performs the corresponding input operation correction based on the operation-related information of the input device 110 from the start time of obtaining the input operation of the input device 110, so as to obtain a corrected input operation, for example, interpreting a mouse drag operation as a mouse click operation, or interpreting mouse drag+click operation as a mouse double-click operation, etc., till satisfying predetermined condition(s) for stopping the input operation correction, for example, the time period of movement of the light-emitting source 111 reaches a predetermined correction delay time threshold and/or the feature value of movement of the application trace of the light-emitting source 111 reaches its corresponding feature value threshold of movement.

For example, from the start time when the application detection device 120 obtains the input operation of the input device 110, e.g., the input operation is a mouse drag operation, if the user operates the input device 110 again to perform a mouse click operation in the mouse drag state such that the mouse drag operation is converted into a mouse click operation at the drag stop position, the application detection device 120 maps the mouse drag+click operation to a mouse double click operation at the original mouse drag start position by means of a predetermined input operation mapping relationship, and meanwhile detects whether to satisfy predetermined condition(s) for stopping an input operation correct. When the time period of movement of the light-emitting source 111 reaches a predetermined correction delay time threshold and/or the feature value of movement of the application trace of the light-emitting source 111 reaches its corresponding feature value threshold of movement, the application detection device 120 stops the input operation correction and restores the previous calculation on the application trace of the light-emitting source 111.

For the predetermined condition of stopping the input operation correction, the application detection device 120 calculates a mouse movement feature in each frame of image after the start time of the input operation of the input device 110; when one or more mouse movement features exceed their respective predetermined thresholds, the input operation correction is stopped, for example, stopping the input operation correction when the mouse motion displacement is large enough. Or, a maximum anti-jitter delay time is preset, e.g., 100 to 200 ms, such that from the start of the motion of the light-emitting source 111, when it reaches the maximum anti jitter delay time, stopping the input operation correction. Here, the mouse movement features include, but not limited to, speed, acceleration or speed, acceleration in the vertical direction of the mouse movement corresponding to each frame of image, and variation amounts of the speed and acceleration in a neighboring frame, or displacement over the mouse click position, or horizontal or vertical component of the displacement.

It should be noted that, those skilled in the art should understand that the correction operation of the application trace start point and the input operation correction are not compulsorily implemented in one embodiment of the present invention, and the correction operation of the application trace start point and the input operation correction may be applied to different embodiments of the present invention, respectively, so as to realize correction of the application trace start point or the correction of the input operation in various preferred embodiments.

For example, the application detection device 120 determines that the input mode of the light-emitting source 111 is a mouse input mode based on the current application of the external device 130, e.g., webpage browsing, and determines a corresponding mouse application mapping curve; the application detection device 120, based on the imaging information of the light-emitting source 111, obtains its motion trace, and calculates the corresponding application trace by means of the mouse application mapping curve; the application detection device 120, before the start time of the motion trace, within a maximum search time range backward, e.g., 100 ms, calculates the recorded mouse movement feature in each frame of image, for example, calculating the mouse movement speed in each frame of image within the preceding 100 ms, so as to take the frame corresponding to the speed peak or the preceding frame as the start position of the application trace to correct the application trace; then, after the application detection device 120 obtains the mouse click operation of the input device 110, the motion caused by the user operating the input device 110 causes the mouse click operation to be converted into a mouse drag operation; the application detection device 120 maps the mouse drag operation back to the mouse click operation and detects whether to satisfy predetermined condition(s) of stopping an input operation correction. When displacement of a certain position in the application trace of the light-emitting source 111 relative to the motion start position or its horizontal or vertical component, exceeds its corresponding threshold, the input operation correction is stopped, and the previous calculation on the application trace of the light-emitting source 111 is restored; the application detection device 120 will output the further calculated application trace to the external device 130.

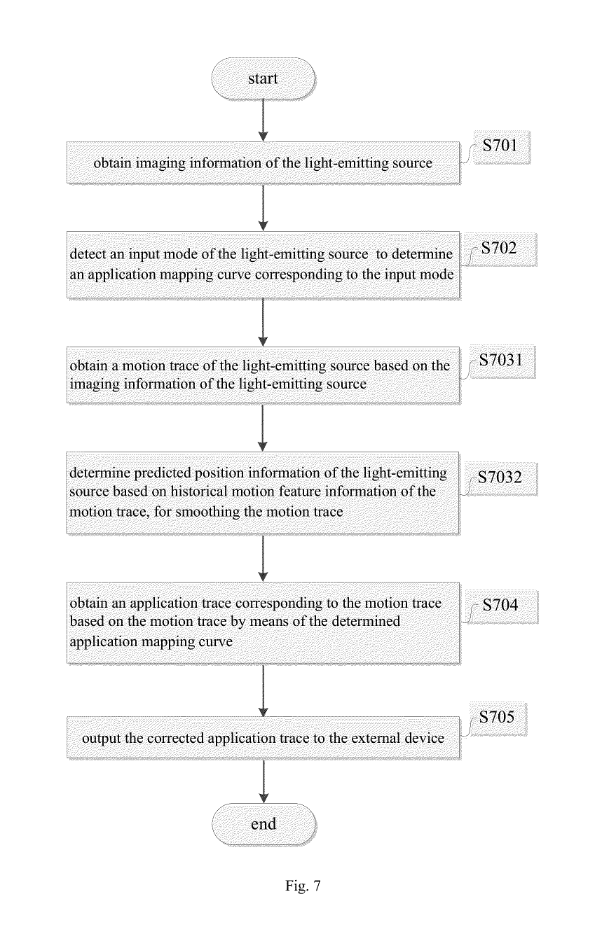

FIG. 7 is a flow chart of a method according to a further preferred embodiment of the present invention, showing a process for mapping a motion trace of a light-emitting source to an application trace thereof.

Here, an application input system 100 comprises an input device 110 and an application detection device 120, wherein the input device 110 and the application detection device 120 are disposed at two ends, respectively. The input device 110 comprises at least one light-emitting source 111. The application detection device 120 has at least one built-in camera 121 or is externally connected to at least one camera 121. The camera 121 shoots a light-emitting source 111 to obtain imaging information of the light-emitting source 111; the application detection device 120 is further connected to an external device 130.

With reference to FIG. 1 and FIG. 7 in combination, in step S701, the camera 121 shoots to obtain imaging information of the light-emitting source 111; in step S702, the application detection device 120 detects an input mode of the light-emitting source 111 to determine an application mapping curve corresponding to the input mode; in step S7031, the application detection device 120 obtains a motion trace of the light-emitting source 111 based on the imaging information of the light-emitting source 111; in step S7032, the application detection device 120 determines predicted position information of the light-emitting source 111 based on historical movement feature information of the motion trace, for smoothing the motion trace; in step S704, the application detection device 120 obtains an application trace corresponding to the motion trace based on the motion trace by means of the determined application mapping curve; in step S705, the application detection device 120 outputs the application trace to the external device 130.

For example, in step S7032, the application detection mouse 120 performs an interpolation smoothing operation about the motion trace. Specifically, a maximum output time interval is preset, e.g., 10 ms, and when the maximum output time interval expires, the application detection device 120 still has does not output the application trace of the light-emitting source 111; the application detection device 120, based on historical movement feature information of the motion trace of the light-emitting source 111, for example, the position, speed, acceleration of the light-emitting source 111 as detected the last time, determines predicted position information of the light-emitting source 111, for example, x′=x+vₓ*t, y′=y+v_{y}*t, wherein v denotes the movement speed, and x′, y′ denotes predicted position information; afterwards, the application detection device 120 obtains a predicted application trace corresponding to the predicted position information based on the predicted position information by means of a corresponding application curve.

Since the frame rate for the camera to acquire images is limited, when the frame rate is relatively low while the light-emitting source 111 moves at a high speed, the sampling ratio for the two-dimensional/three-dimensional motion trace as obtained through detecting by the application detection device 120 could be insufficient, which might deteriorate the user experience. For example, the mouse application trace generated by the two-dimensional/three-dimensional motion trace will be not smooth as being interrupted intermittently; according to the above process, by interpolating the predicted position information, the smoothness of the motion trace will be enhanced, thereby the corresponding mouse application trace will also be smooth and fluent, without being paused intermittently.

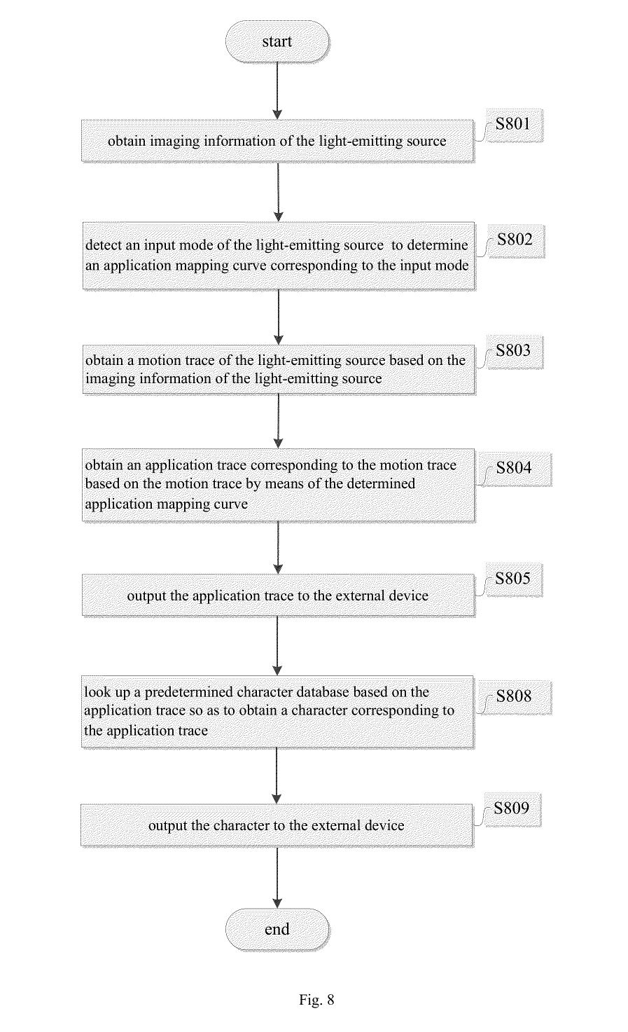

FIG. 8 is a flow chart of a method according to a still further preferred embodiment of the present invention, showing a process for mapping a motion trace of a light-emitting source to an application trace thereof.

Here, an application input system 100 comprises an input device 110 and an application detection device 120, wherein the input device 110 and the application detection device 120 are disposed at two ends, respectively. The input device 110 comprises at least one light-emitting source 111, and the input mode of the light-emitting source 111 comprises a handwriting input mode. The application detection device 120 has at least one built-in camera 121 or is externally connected to at least one camera 121. The camera 121 shoots a light-emitting source 111 to obtain imaging information of the light-emitting source 111; the application detection device 120 is further connected to an external device 130.

With reference to FIG. 1 and FIG. 8 in combination, in step S801, the camera 121 shoots to obtain imaging information of the light-emitting source 111; in step S802, the application detection device 120 detects an input mode of the light-emitting source 111 to determine an application mapping curve corresponding to the input mode; in step S803, the application detection device 120 obtains a motion trace of the light-emitting source 111 based on the imaging information of the light-emitting source 111; in step S804, the application detection device 120 obtains an application trace corresponding to the motion trace based on the motion trace by means of the determined application mapping curve; in step S805, the application detection device 120 outputs the application trace to the external device 130; in step S808, the application detection device 120 looks up a predetermined character database based on the application trace so as to obtain a character corresponding to the application trace; in step S809, the application detection device 120 outputs the character to the external device 130.

For example, the application detection device 120 detects that the input mode of the light-emitting source 111 is a handwriting input mode and determines that the corresponding application mapping curve is a linear curve with a slope of 5 (i.e., transformation coefficient); the application detection device 120 obtains the motion trace of the light-emitting source 111 based on the imaging information of the light-emitting source 111, for example, position information of the imaging light spot of the LED light source in each frame of image according to a motion trace of the imaging light spot formed in a consecutive image sequence by target tracking; after calculating and outputting corresponding application trace based on the motion trace of the light-emitting source 111, the application detection device 120 further looks up a character database based on the application trace so as to obtain a character corresponding to the application trace and output the character to the external device 130.

Here, the transform coefficient may be determined based on statistical habits of a plurality of users or pre-set by a user or the application detection device 120, or determined through adjustment performed by the application detection device 120 on a default value based on the current user's use habits. The application mapping curve may determine a corresponding screen input position based on a position of the imaging light spot relative to a fixed point (for example, an upper left point of the image); or determine movement distance or speed of a corresponding screen track based on the movement distance or speed of the imaging light spot, for example, mapping the movement distance or speed of the light-emitting source 111 to the position and length of an input stroke.

Preferably, the application detection device 120 further detects the current input state of the light-emitting source 111, e.g., input state or waiting state; when the waiting time corresponding to the input state expires, a predefined character base is inquired based on the determined application trace so as to obtain a character corresponding to the application trace and output the character to the external device 130.

For example, in the input state, the waiting time between strokes is T1; in the wait state, the waiting time between strokes is T2, and T2<T1. When the waiting time expires, it is deemed that the user finishes a character, and then the character recognition starts automatically, for example, a predetermined character database is inquired based on the application tack determined by the motion trace of the light-emitting source 111 so as to obtain a character corresponding to the application trace. When the wait state is switched into the input state, while the user does not input a stroke, the wait time may be counted from the completion of the last stroke input for the time of wait state so as to prevent the system from waiting endlessly, i.e., the longest inter-stroke waiting time does not exceed T1.

For another example, when the application detection device 120 uses the screen input position of the light-emitting source 111 to detect the input state and the waiting state: if the screen input position, for example, the position of the input cursor, is within the handwriting input area, the inter-stroke waiting time is T1; if the screen input position is beyond the handwriting input area, the inter-stroke waiting time is T2, and T2<T1. When the waiting time expires, it is deemed that the user completes a character, and then character recognition starts automatically. Therefore, when the user is still inputting and the screen input position is within the handwriting input area, the waiting time is long; while when the user moves the input cursor beyond the handwriting input area, the waiting time is short.

Here, the handwriting input area may be a fixed area on a screen of the external device 130, for example, a central area of the screen, or an area determined dynamically based on the starting point of the application trace. For example, based on the starting point of the application trace, i.e., the initial position of the handwriting input where the pen touches the screen, a certain displacement area is extended upward, downward, leftward, and rightward, to determine a handwriting input area corresponding to the handwriting input mode. The size of the area may be a sufficient space for the user to write a character.

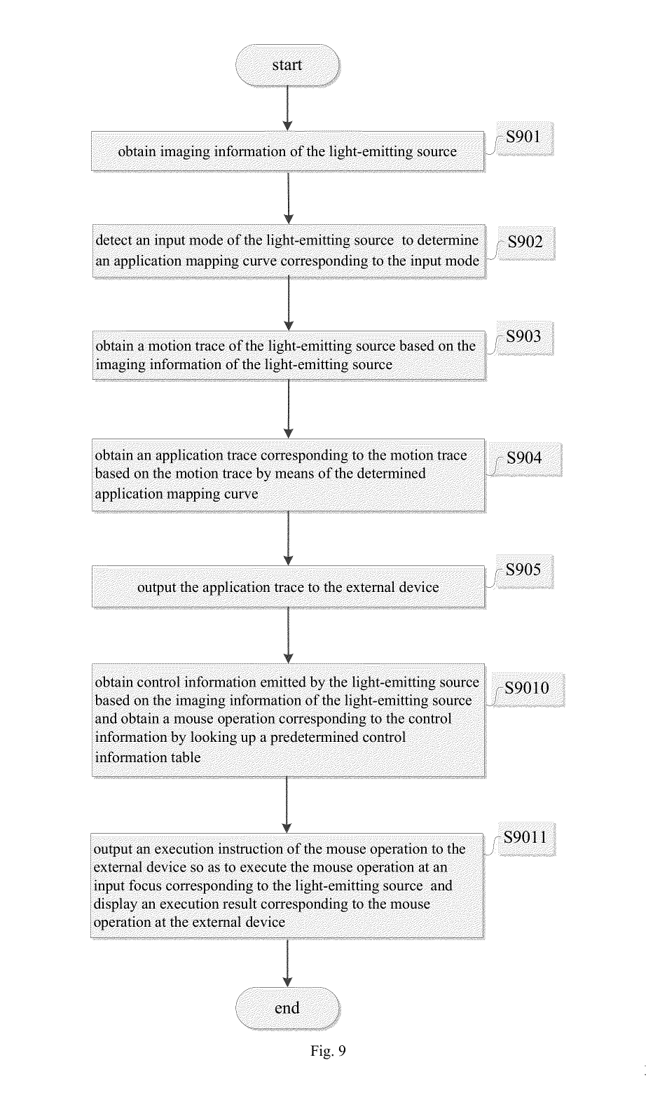

FIG. 9 is a flow chart of a method according to a yet further preferred embodiment of the present invention, showing a process for mapping a motion trace of a light-emitting source to an application trace thereof.

Here, an application input system 100 comprises an input device 110 and an application detection device 120, wherein the input device 110 and the application detection device 120 are disposed at two ends, respectively. The input device 110 comprises at least one light-emitting source 111, and the input mode of the light-emitting source 111 comprises a mouse input mode. The application detection device 120 has at least one built-in camera 121 or is externally connected to at least one camera 121. The camera 121 shoots a light-emitting source 111 to obtain imaging information of the light-emitting source 111; the application detection device 120 is further connected to an external device 130.

With reference to FIG. 1 and FIG. 9 in combination, in step S901, the camera 121 shoots to obtain imaging information of the light-emitting source 111; in step S902, the application detection device 120 detects an input mode of the light-emitting source 111 to determine an application mapping curve corresponding to the input mode; in step S903, the application detection device 120 obtains a motion trace of the light-emitting source 111 based on the imaging information of the light-emitting source 111; in step S904, the application detection device 120 obtains an application trace corresponding to the motion trace based on the motion trace by means of the determined application mapping curve; in step S905, the application detection device 120 outputs the application trace to the external device 130; in step S9010, the application detection device 120 obtains control information emitted by the light-emitting source 111 based on the imaging information of the light-emitting source 111 and obtains a mouse operation corresponding to the control information by looking up a predetermined control information table; in step S9011, the application detection device 120 outputs an execution instruction of the mouse operation to the external device 130 so as to execute the mouse operation at an input focus corresponding to the light-emitting source 111 and displays an execution result corresponding to the mouse operation at the external device 130.

For example, in the mouse input mode, the user performs various kinds of mouse operations on the keys arranged on the input device 110, and controls the light-emitting source 111 to emit light according to a certain flickering frequency, thereby enabling the application detection device 120 to obtain a corresponding mouse operation by detecting a flickering frequency. The application detection device 120, besides obtaining and outputting a corresponding application trace based on the motion trace of the light-emitting source 111, further obtains the flickering frequency of the light-emitting source 111 based on the imaging information of the light-emitting source 111 through calculating the times of lighting of the imaging light spot of the light-emitting source 111 within a certain period of time, and looks up a predetermined control information table based on the flickering frequency to obtain a corresponding mouse operation, e.g., a click operation; afterwards, the application detection device 120 outputs the execution instruction of the mouse operation to the external device 130 so as to execute the click operation at the current mouse position and present a corresponding execution result on a screen of the external device 130.

It should be noted that the present invention may be implemented in software or a combination of software and hardware; for example, it may be implemented by an ASIC (Application Specific Integrated Circuit), a general-purpose computer, or any other similar hardware devices.

The software program of the present invention may be executed by a processor to implement the above steps or functions. Likewise, the software program of the present invention (including relevant data structure) may be stored in a computer readable recording medium, for example, a RAM memory, a magnetic or optical driver, or a floppy disk, and other similar devices. Besides, some steps or functions of the present invention may be implemented by hardware, for example, a circuit cooperating with a processor to execute various functions or steps.

Additionally, a portion of the present invention may be applied as a computer program product, for example, a computer program instruction, which, may invoke or provide a method and/or technical solution according to the present invention through operations of the computer when executed by the computer. Further, the program instruction invoking the method of the present invention may be stored in a fixed or mobile recording medium, and/or transmitted through broadcast or data flow in other signal bearer media, and/or stored in a working memory of a computer device which operates based on the program instruction. Here, one embodiment according to the present invention comprises an apparatus comprising a memory for storing a computer program instruction and a processor for executing the program instruction, wherein when the computer program instruction is executed by the processor, the apparatus is triggered to run the methods and/or technical solutions according to a plurality of embodiments of the present invention.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims instead of the above description, and all variations intended to fall into the meaning and scope of equivalent elements of the claims should be covered within the present invention. No reference signs in the claims should be regarded as limiting of the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method for mapping a motion trace of an light-emitting source to its application trace, comprising the following steps:
obtaining imaging information of the light-emitting source;
wherein the method further comprises:
a. detecting an input mode of the light-emitting source to determine an application mapping curve corresponding to the input mode;
b. obtaining a motion trace of the light-emitting source based on the imaging information;
c. obtaining an application trace corresponding to the motion trace, by means of the application mapping curve, based on the motion trace;
d. outputting the application trace to an external device.

2. The method according to claim 1, wherein the operation of detecting the input mode of the light-emitting source comprises:
determining the input mode of the light-emitting source based on the current application of the external device.

3. The method according to claim 1, further comprising:
correcting a start point of the application trace based on a peak of movement feature of the motion trace or the application trace within a predetermined search time range;
wherein, the step d comprises:
outputting the corrected application trace to the external device.

4. The method according to claim 1, wherein before the step d, the method further comprises:
correcting a corresponding input operation based on information relevant to operation of the input device from a start time of obtaining an input operation of the input device, so as to obtain a corrected input operation, till predetermined condition(s) for stopping the input operation correction being met;
wherein, the predetermined condition(s) for stopping an input operation correction comprises at least one of the following items:
a time period of movement of the light-emitting source reaching a predetermined correction delay time threshold;
a feature value of movement of the motion trace of the light-emitting source reaching a corresponding feature value threshold of movement;
a feature value of movement of the application trace of the light-emitting source reaching a corresponding feature value threshold of movement.

5. The method according to claim 1, wherein the step b further comprises:
determining predicted position information of the light-emitting source based on historical movement feature information of the motion trace so as to smooth the motion trace.

6. The method according to claim 1, wherein the application mapping curve comprises a three-dimensional application mapping curve.

7. The method according to claim 6, wherein an amplification factor of the three-dimensional application mapping curve is adjusted based on a distance to the light-emitting source.

8. The method according to claim 6, wherein the three-dimensional application mapping curve comprises a three-dimensional application mapping curve based on a three-dimensional rotational position of the light-emitting source.

9. The method according to claim 8, wherein the step b comprises:
obtaining a three-dimensional rotational motion trace of the light-emitting source based on the imaging information.

10. The method according to claim 1, wherein the application mapping curve is adjusted by historical state information of the light-emitting source.

11. The method according to claim 1, wherein before the step b, the method further comprises:
detecting a current input state of the light-emitting source, so as to proceed further operation when the waiting time corresponding to the current input state expires.

12. The method according to claim 1, wherein the input mode of the light-emitting source comprises a handwriting input mode.

13. The method according to claim 12, wherein the application mapping curve comprises a linear curve.

14. The method according to claim 12, further comprising:
looking up a predetermined character database based on the application trace so as to obtain a character corresponding to the application trace; and
outputting the character to the external device.

15. The method according to claim 12, wherein the method further comprises:
determining an input area corresponding to the handwriting input mode based on a start point of the application trace.

16. The method according to claim 1, wherein the input mode of the light-emitting source comprises a mouse input mode.

17. The method according to claim 16, further comprising:
obtaining control information transmitted by the light-emitting source based on the imaging information of the light-emitting source, and obtaining a mouse operation corresponding to the control information by means of looking up a predetermined control information table;
outputting an execution instruction of the mouse operation to the external device so as to execute the mouse operation at an input focus corresponding to the light-emitting source, and displaying the executing result corresponding to the mouse operation at the external device.

18. A system of mapping a motion trace of an light-emitting source to its application trace, wherein the system comprises an light-emitting source, a camera for capturing imaging information of the light-emitting source, a processing module, and an output module;
wherein the processing module is configured to:
detect an input mode of the light-emitting source to determine an application mapping curve corresponding to the input mode;
obtain a motion trace of the light-emitting source based on the imaging information;
obtain an application trace corresponding to the motion trace, by means of the application mapping curve, based on the motion trace;
wherein the output module is configured to output the application trace to an external device.
